(19) United States
(12) Patent Application Publication
(10) Pub. No.: US 2015/0285595 A1
(43) Pub. Date: Oct. 8, 2015

(54) PROTECTIVE GLAZING COMPRISING TRANSPARENT CERAMICS

(71) Applicant: SCHOTT AG, Mainz (DE)

(72) Inventors: Petra AUCHTER-KRUMMEL, Vendersheim (DE); Wolfram BEIER, Essenheim (DE); Bernd HOPPE, Ingelheim (DE); Yvonne MENKE, Wiesbaden (DE); Thilo ZACHAU, Neuengoenna (DE)

(21) Appl. No.: 14/745,195

(22) Filed: Jun. 19, 2015

Related U.S. Application Data
(63) Continuation of application No. PCT/EP2012/076192, filed on Dec. 19, 2012.

(51) Int. Cl. F41H 5/04; B32B 9/00; B32B 37/18; B32B 7/02; B32B 17/10; G02B 1/14; B32B 9/04

(52) U.S. Cl. CPC F41H 5/0407; G02B 1/14; B32B 9/005; B32B 9/045; B32B 7/02; B32B 17/10018; F41H 5/0428; B32B 37/18; B32B 2307/418; B32B 2307/558; B32B 2571/02; B32B 2307/412; B32B 2551/00

(57) ABSTRACT

Armored glasses for windows in all kinds of vehicles, aircraft, missiles of all types, marine and underwater vehicles of all types and/or buildings and manufacturing methods are provided. The armored glass is a composite having at least one opto-ceramic layer having a front side and a rear side and a film of a transparent material disposed on the front and/or rear side of the opto-ceramic layer and integrally connected to the opto-ceramic layer so that the transparency of the composite is greater than the transparency of the opto-ceramic layer alone. The film of the transparent material renders roughnesses of the front and/or rear side of the opto-ceramic layer substantially optically ineffective.

### CROSS REFERENCE TO RELATED APPLICATIONS

This application is a continuation of International Application No. PCT/EP2012/076192 filed Dec. 19, 2012, the entire contents of all of which are incorporated herein by reference.

### BACKGROUND OF THE INVENTION

1. Field of the Invention

The present invention relates to a protective glazing for windows for all types of vehicles, such as cars and trains, aircraft and missiles of all kinds, and marine and underwater vehicles of all kinds, and/or buildings, and also relates to a manufacturing method for the protective glazing.

2. Description of Related Art

Antiballistically effective transparent sheet composites or protective glazing, commonly referred to as bulletproof glass or armored glass, are known per se and conventionally comprise a composite of glass and resin layers or sheets bonded to each other.

It is also known to incorporate a layer of a ceramic material into the composite, for example an opto-ceramic layer. Examples of opto-ceramics include spinel, AlON, and sapphire.

Document DE 20 2008 014 264 U1, for example, discloses an armored glass composite panel which is composed of several layers of glass or resin sheets and at least one layer of juxtaposed transparent ceramic plates, the layers being joined to each other by a bonding means.

However, the sheets described therein have to be completely transparent in order to achieve the transparency of the composite. A complete or at least sufficient transparency is generally achieved by having both sides, the front side and the rear side of the sheet polished almost perfectly, that means to optical quality. However, the polishing to optical quality, i.e. to substantially complete transparency, is extremely time consuming and costly.

### SUMMARY

Given the background described above, the present invention is based on the object to overcome or at least mitigate the drawbacks of the prior art.

At the same time it should be possible to exploit the advantages of opto-ceramics in an antiballistic transparent multilayer composite without the need to perform laborious reworking measures, such as polishing to optical quality.

These objects are achieved by the armored glass composite and the manufacturing method for such a composite according to the present disclosure.

Generally, the invention contemplates to use an opto-ceramic that is not polished to optical quality, and to compensate for the transparency-reducing irregularities and/or roughnesses existing on the surface by applying a transparent film, for example a suitable polymer film. This transparent film lies on and/or into the surface texture of the opto-ceramic so as to substantially render optically ineffective the unevenness and/or roughness of the surface. The surface of the opto-ceramic itself may even be so uneven and/or rough and have such a low transparency that it is not possible to view through the opto-ceramic. Therefore, in particular the laborious and expensive polishing to obtain a surface of especially optical grade can be dispensed with.

In detail, the present invention is described by a transparent armored glass composite comprising at least one layer of an opto-ceramic material, or opto-ceramic layer, having a front side and a rear side, and a film of a transparent material disposed on the front side and/or on the rear side of the opto-ceramic layer, which is integrally connected to the opto-ceramic layer so that the transparency of the composite is greater than the transparency of the opto-ceramic layer alone.

Furthermore, the invention comprises a method for producing a transparent armored glass composite, which comprises providing an opto-ceramic as one layer of an armored glass composite and bonding at least one film of a transparent material to a front side and/or a rear side of the opto-ceramic such that the transparency of the composite is increased when compared to the transparency of the opto-ceramic.

The armored glass composite of the invention is in particular producible or has been produced by the method according to the invention. The method of the invention is preferably adapted for producing the armored glass composite according to the invention. The armored glass composite may also be referred to as a protective glazing.

An opto-ceramic is a ceramic material for optical applications. Opto-ceramics differ from conventional glass ceramics in that the latter have a high proportion of amorphous glass phase in addition to a crystalline phase. Furthermore, conventional ceramics have high porosities, which are not present in opto-ceramics. An opto-ceramic is an intrinsically transparent or translucent body.

Transparency in the visible wavelength range of electromagnetic radiation, also referred to as light, refers to a net transmittance (i.e. the light transmittance minus reflection losses) which, in a range having a width of at least 200 nm, for example in a wavelength range from 400 nm to 600 nm or in a wavelength range from 450 nm to 750 nm or preferably in a wavelength range from 500 nm to 800 nm or more preferably in the range of visible light with wavelengths from 380 nm to 800 nm, is greater than 20%, preferably greater than 40%, more preferably greater than 60%, most preferably greater than 80%. This applies to a thickness of at least 0.5 mm, preferably at least 1 mm, more preferably at least 3 mm, most preferably a thickness of at least 4 mm, or even at least 10 mm.

Whether an opto-ceramic is transparent or only translucent is largely determined by the microstructure of the ceramic and also by the nature of the surface of an opto-ceramic, in particular by unevennesses and/or roughnesses thereof. An opto-ceramic body is a molded body consisting of small particles or a kind of powder, wherein the small particles are joined together by sintering. In this case, the individual crystallites are arranged densely, and generally densities of at least 99%, preferably at least 99.9%, and particularly preferably at least 99.99% , with respect to the theoretical values, are obtained. Thus, the opto-ceramics are almost free of pores. Consequently, an opto-ceramic is a sintered body. The small particles of the sintered body may be provided, for example, with a size distribution from 0.5 μm to 500 μm, and the starting materials may have a significantly smaller grain size, even a primary particle size below 50 nm.

The opto-ceramic which is used as a layer in the armored glass composite will be briefly referred to as an opto-ceramic layer below. The opto-ceramic layer or the opto-ceramic employed is optically translucent or transparent before being joined with the film(s) of the rest of the armored glass composite. The opto-ceramic layer is transparent or translucent at least for electromagnetic radiation in the range of wavelengths which is perceptible to the human eye.

Generally, a material is referred to as being optically transparent or translucent when an object arranged behind the material can be seen relatively clearly. Transparency can therefore be described as transmissibility for images or to the view. In contrast to transparency, translucence can be described as transmissibility for light, but without giving a clear image of an object arranged behind, due to scattering effects, for example.

The opto-ceramic layer may be transparent, but does not necessarily have to be transparent. According to the invention, it is even sufficient if the opto-ceramic layer is only translucent. The front side and/or the rear side of the opto-ceramic may be rough and/or uneven to an extent so that the transmitted light is so diffuse that no clear or sharp image of an object arranged behind can be seen, or even so that only dark and light areas are visible.

One measure of the transparency and/or translucency is the transmittance for light of the opto-ceramic layer. Prior to be joined to the one or more film(s) of the rest of the armored glass composite, the opto-ceramic layer that has optionally been processed has a total transmittance which in a range having a width of at least 200 nm, for example in a wavelength range from 400 nm to 600 nm or in a wavelength range from 450 nm to 750 nm or preferably in a wavelength range from 500 nm to 800 nm or more preferably in the range of visible light with wavelengths from 380 nm to 800 nm, is greater than 20%, preferably greater than 40% and/or less than 80%, preferably less than 70%. This applies to a thickness of at least 0.5 mm, preferably at least 1 mm, more preferably at least 3 mm, most preferably a thickness of at least 4 mm, or even at least 10 mm.

FIGS. 9.a and 9.b illustrate transmittance data of opto-ceramics having a thickness of 4 mm. Transmittance was determined using a commercially available transmittance measuring device in which the sample is placed in the beam path of a standard illuminant directly at the opening of an (Ulbricht) integration sphere that includes an internal detector, and the radiation transmitted is detected by a connected spectrometer, and transmittance is determined by comparison with the radiation detected without sample. Here, the transmittance is called total measured transmittance of the sample sheet because both the directly transmitted and the scattered portions of the incident radiation including the Fresnel losses at the two surfaces of the transmitted sample sheet are detected. This measurement will be referred to as PvK measurement below. All transmittance values given in the present application always refer to the measuring method described above.

The transmission of light through the opto-ceramic layer is furthermore influenced by the unevenness and/or roughness of the front side and/or the rear side of the opto-ceramic layer. Therefore, the unevenness and/or roughness is also a measure for the transparency and/or translucency of the opto-ceramic layer.

Prior to being joined to the one or more film(s) of the rest of the armored glass composite, the opto-ceramic layer exhibits a surface finish that is comparable to the surface which is obtain, for example, when the surface has been treated by grinding with sandpaper grit P1000 (grain size of 18.3 μm±1 μm), or at most up to P5000 (grain size of 5 μm), preferably with sandpaper having a grit of not more than P600 (grain size of 25.8 μm±1 μm), more preferably with sandpaper having a grit of not more than P320 (grain size of 46.2 μm±1.5 μm), even more preferably with sandpaper having a grit of not more than P240 (grain size of 58.5 μm±2 μm), or most preferably by milling which is roughly similar to sanding with sandpaper of grit P240. The aforementioned sandpaper grits are given according to the standard FEPA P (Federation Européenne des Fabricants de Produits Abrasifs) of the Federation of the European Producers of Abrasives. FEPA distinguishes between grits for paper (FEPA P) and abrasive grains (FEPA F), e.g. for grindstones. FEPA P grain sizes are only used for paper, for a comparison with other standards FEPA F grits also have to be considered. Depending on the hardness of the opto-ceramic and the manner of performing the grinding process(es), surfaces with specific roughnesses are achieved.

Typically, opto-ceramic surfaces have: roughness characteristics with Ra value of 0.04 um, RMS value of 0.08 μm after sanding with sandpaper grit P1000; roughness characteristics with Ra value of 0.36 μm, RMS value of 0.49 um after sanding with sandpaper grit P600; roughness characteristics with Ra value of 0.67 um, RMS value of 0.89 μm after sanding with sandpaper grit P320; roughness characteristics with Ra value of 1.72 μm, RMS value of 2.25 μm after sanding with sandpaper grit P240; roughness characteristics with Ra value of 1.60 μm, RMS value of 2.07 μm after milling.

By contrast, polished opto-ceramic surfaces typically have roughness characteristics with Ra value of <0.01 μm, RMS value of <0.01 μm.

In one embodiment, the opto-ceramic layer has a roughness of greater than approximately 0.01 μm (Ra value) and/or greater than approximately 0.01 μm (RMS value), preferably of greater than approximately 0.1 um (Ra value) and/or greater than approximately 0.1 μm (RMS value), more preferably greater than approximately 1 μm (Ra value) and/or greater than approximately 1 μm (RMS value). In one embodiment, the roughness in Ra values and/or RMS values is in a range below approximately 10.0 μm, preferably below approximately 4.0 μm, more preferably below approximately 2.2 μm.

After joining, in particular joining of the opto-ceramic layer with the transparent film, the composite has a transmittance (as measured with PvK measurement) in a range of greater than 40%, preferably greater than 60%, more preferably of greater than 70%, or greater than 80%. Haze (turbidity) as a measure of scattering is intended to be in a range of <10%, preferably <5%, more preferably <2%, most preferably <1%.

The ratio of the transmittance of the composite to the transmittance of the opto-ceramic layer is in a range from 0.3 to 10, preferably from greater than 1 to 8, particularly preferably from greater than 1 to 3.

Preferably, the opto-ceramic layer has a thickness from 0.5 mm to 100 mm. The opto-ceramic layer is provided by at least one ceramic selected from a group including Mg-spinel, Zn-spinel, AlON, sapphire, and pyrochlore (A₂B₂O₇, wherein A is at least one trivalent cation from the group of rare earth oxides, preferably Y, Gd, Yb, Lu, La, Sc, and/or wherein B is at least one tetravalent cation, in particular Ti, Zr, Hf, Sn, and/or Ge), and ZnS opto-ceramic. The aforementioned ceramics may likewise be provided as mixed crystal ceramics or structures. The above list is meant to be exemplary and the invention is not limited to the above selection.

As already stated above, the opto-ceramic is produced by sintering. Once the sintered body has been produced, its surface generally need to be cleaned since the surface is usually covered by a disturbing film such as a graphite film which may result from contact with the inner surface of a mold. Also, foreign particles might be incorporated into the surface or the layer near the surface, which may have been caused by the sintering process.

This disturbing film and possibly near-surface regions must be removed. That is to say the opto-ceramic must be cleaned after sintering. The opto-ceramic or the upper surface of the opto-ceramic may be processed, for example, by milling, lapping, ultrasonic lapping, sandblasting, grinding, sawing, etching, laser processing, and/or ion beam processing. The aforementioned list is meant to be exemplary and the invention is not limited to the aforementioned selection. Other material removing processes may likewise be employed.

In addition, the surface usually exhibits a high roughness after sintering.

In order to obtain a surface of optical grade, the front side and rear side of the opto-ceramic is often grinded and washed several times while successively reducing the grain size of the employed abrasive. Finally, the front side and the rear side of the opto-ceramic are polished in order to obtain an opto-ceramic of optical grade or quality.

The final step of polishing is the most time-consuming and hence costly step. As a rule, more than half of the total surface processing time for the opto-ceramic is attributable to the polishing step. The inventors have found that the polishing to optical quality is unnecessary if according to the invention the transparent film is applied on the front side and/or rear side of the opto-ceramic layer.

Therefore, in one embodiment the armored glass composite is characterized in that the front side and/or rear side of the opto-ceramic is/are not polished to optical grade. A surface of optical grade or quality generally has a roughness in Ra value of less than 10 nm. The front side and/or the rear side according to the invention, by contrast, exhibit a larger roughness (see the text above).

Furthermore, the inventors have found that even an opto-ceramic with an extremely rough surface may be used, so that even the treatment of successive grinding and washing can be dispensed with. It is only necessary to remove the disturbing film caused by the sintering process, for example by milling.

Therefore, in one embodiment the armored glass composite is characterized in that the front side and/or rear side of the opto-ceramic is/are cleaned after sintering, preferably by milling, lapping, ultrasonic lapping, sandblasting, grinding, sawing, etching and/or processing the front side and/or rear side by another material removing process. Generally, the surface treating process is recognizable in the processed surface as a “fingerprint”.

The strength or fracture behavior of the opto-ceramic is essentially determined by the properties of the surface of the opto-ceramic. In one embodiment, the surface of the opto-ceramic is sandblasted. By sandblasting the opto-ceramic, its surface is damaged substantially evenly. A result thereof is that the bending strength distribution is narrower than that of a polished surface. A defined narrow distribution is achieved.

In the composite, when combined with the opto-ceramic layer, the transparent film is transparent. However, it is not imperative that the material is transparent prior to being joined with the opto-ceramic layer. It is likewise possible that the transparency of the film is for example only produced when having been joined and/or when being joined with the opto-ceramic layer, for example by curing or crosslinking of the material. In particular when having been joined with the opto-ceramic layer, the transparent film exhibits a net transmittance, after deduction of the Fresnel losses, in a range from 10% to greater than or equal to 95%.

To compensate for the optical defects of the front side and/or the rear side of the opto-ceramic layer, it is not necessary for the transparent film and the opto-ceramic layer to have the same refractive index. To be able to compensate for the optical defects as effectively as possible, however, in a preferred variation of the invention the refractive index of the opto-ceramic layer and the refractive index of the film which is disposed on the opto-ceramic layer are matched to each other. Preferably, the difference between the refractive index of the opto-ceramic layer and the refractive index of the film disposed on the opto-ceramic layer is less than 0.7, more preferably less than 0.5, most preferably less than 0.25.

In a preferred embodiment, the composite does not only comprise the opto-ceramic layer and the film, rather further layers and/or films may be provided. Therefore, the armored glass composite is characterized in that the composite comprises at least one further layer of a transparent material which is disposed on the front side and/or the rear side of the opto-ceramic layer and is joined to the composite by means of the film and/or by a further film.

Generally, the opto-ceramic layer and/or at least one further layer is/are provided as a kind of a sheet. The at least one further layer preferably has a thickness from 0.5 mm to 100 mm.

Preferably, the transparent material of the at least one further layer is at least one material selected from a group including glass, glass ceramics, resins, ceramics, and opto-ceramics. The above list is meant to be exemplary and the invention is not limited to the aforementioned selection. Another transparent or translucent material may likewise be used.

In a preferred embodiment of the invention, a sheet of a transparent inorganic material is disposed on the front side and/or the rear side, preferably on the front side, which need not have to be mechanically polished. In particular, a glass sheet with floated or polished surface may be used, in particular with fire-polished surface. However, rolled glass and glass ceramic sheets are also conceivable.

In this manner it is possible to avoid expensive polishing processes, since a material may be used for the final layer of the composite, which has a smooth surface and need not have to be polished laboriously.

This last layer preferably has a roughness Ra of less than 20 nm, particularly preferably of less than 15 nm. Most preferably, the outermost layer has a surface roughness Ra from 2 to 10 nm.

Thus, this outermost layer which is also referred to as a first further layer is intended to ensure a sufficiently smooth surface of the armored glass composite rather than serving as a functional layer for an antiballistic effect of the composite.

At the same time, however, just the first sheet may be provided with additional functionalities, in particular in form of a heated or colored sheet.

In one embodiment of the invention, the armored glass composite comprises at least two opto-ceramic layers which are arranged one above the other.

In order to improve the antiballistic effect, different materials may be used for this purpose, for example a combination of at least two different layers selected from the materials spinel, AlON, and sapphire.

In one embodiment of the invention, at least a first sheet, i.e. the outermost sheet of the composite, has a roughened lower surface.

The outermost sheet may be roughened by an etching process, for example, so as to ensure enhanced adhesion to the resin film which joins the first sheet to an additional layer, or to a TCO film.

In one embodiment of the invention, the armored glass composite comprises a film of a resin material which contains inorganic nanoparticles.

The inorganic nanoparticles which are provided in the resin as a filler may serve to adjust the refractive index of the resin.

For example, titanium oxide particles may be embedded to increase the refractive index.

It is in particular possible to first apply the resin filled with nanoparticles onto the opto-ceramic layer to fill the rough surface of the opto-ceramic layer.

In one embodiment of the invention, a further resin is then used which has a different refractive index, for example a resin not filled with nanoparticles.

In this manner, a resin layer is obtained that has a refractive index gradient, with a non-filled resin usually providing a better material bond between the layers.

Some specific examples for the materials mentioned are set out as follows: The glass is at least one glass selected from a group including borosilicate glass (e.g. Borofloat®), soda-lime-silicate glass, reinforced glass, fused quartz glass, Vycor PMMA nanocomposite, Na-reduced glasses (AF . . . ), tempered K-Na glasses or boro glasses, Li—Na glass ceramics, and spinel glass ceramics; and/or the glass ceramic is at least one glass ceramic selected from the group including Resistan®, newly developed glass ceramics, lithium silicate glass ceramics, and spinel glass ceramics; and/or the resin is or comprises a thermoplastic, thermosetting and/or elastomer resin. The resin is preferably at least one resin selected from a group including PMMA, polyurethane, polycarbonate, nanocomposite polymers, other more sophisticated polymers, PVB, and EVA.

The above list is meant to be exemplary and the invention is not limited to the aforementioned selection.

Generally, the transparent film and/or the at least one further transparent film is thinner than the opto-ceramic layer and/or thinner than the at least one further layer. The films may be intermediate films which preferably have an adhesion promoting function. Preferably, the transparent film and/or the at least one further transparent film has a thickness from 0.001 mm to 10 mm.

In a first variation of the invention, the material for the at least one further film and/or for the transparent film may be provided as a kind of a flexible film which is incorporated into the composite or applied thereon as a coating. For example, a flexible film may be laminated to the composite.

In a second variation of the invention, the material for the at least one further film and/or for the transparent film may be provided in liquid and/or gaseous form and applied to the composite and transformed into a solid thereon, for example by being cross-linked and/or cured. To this end, the material of the film and/or of the further film may be heated, dried, or irradiated, preferably using UV radiation, IR radiation, and/or microwave radiation. The material for the transparent film and/or for the at least one further film may for example be applied by spraying and/or by a sol-gel method (e.g. alkoxide gel method, substantially purely inorganic methods, and/or inorganic/organic hybrid methods).

The transparent material of the film and/or the material of the at least one further film is at least one material selected from a group including resin, glass, and glass-ceramics.

Some specific examples for the materials mentioned are set out as follows: The glass is at least one glass selected from a group including borosilicate glass (e.g. Borofloat®), soda-lime-silicate glass, reinforced glass, fused quartz glass, and Vycor PMMA nanocomposite; and/or the resin is or comprises a thermoplastic, thermosetting and/or elastomer resin. The resin is preferably at least one resin selected from a group including PMMA, polyurethane, polycarbonate, nanocomposite polymers, other more sophisticated polymers, PVB, and EVA.

In a further embodiment of the invention, the armored glass composite is characterized by at least one functional layer in the composite, which is provided as a separate film and/or as a separate layer in the composite, and/or which is integrated in the opto-ceramic layer, in the film, in the at least one further layer, and/or in the at least one further film. Preferably, the functional layer is at least one layer selected from a group including heating layer, anti-fog layer, anti-reflective layer, vapor-deposited glass layer for refractive index matching, photochromic layer, electrochromic layer, thermochromic layer, IR-absorbent layer, IR-reflective layer, radiation-reflective layer, and anti-scratch layer, (e.g. diamond-like carbon (DLC) coating against mechanical abrasion) and other functional layers, but this list is not limiting.

In a further embodiment, at least the opto-ceramic layer is provided by an array of individual plates. This permits to limit damage caused by projectiles to portions of the composite and thus to improve multi-hit capability.

Another embodiment is characterized in that the opto-ceramic layer and/or the composite is curved, at least in portions thereof. This permits to improve lateral vision through the composite. One example of manufacturing a curved opto-ceramic is by molding the green body using a near-net shape process and then sintering the same.

The armored glass composite according to the invention is a device for protection against direct and/or indirect, preferably dynamic impacts. Preferably, the armored glass composite of the invention is a device for protecting in particular people in vehicles, aircraft, watercraft, underwater vehicles and/or buildings against a ballistic or other dynamic mechanical impact, such as bird strike, rain (in fast-flying flying objects), pressure waves, ice, and/or hail. In common parlance, this is often referred to as bulletproof glass, ballistic glass, or bullet-resistant glass laminate sheet. Although the device of the invention is referred to as an armored glass composite, it is however not imperative that the composite includes glass. It may include a glass sheet, for example as a further layer, but this is not a must. In one embodiment, the composite has a total thickness from 5 mm to 250 mm.

Also within the scope of the invention is a window pane for civilian and/or military vehicles, aircraft and/or buildings and/or protective clothing for people, which comprises an armored glass composite of the invention.

The present invention will now be described in more detail by way of the following exemplary embodiments, for which purpose reference is made to the accompanying drawings. The same reference numerals in the individual drawings refer to the same parts.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a cross-sectional view illustrating an embodiment of an armored glass composite according to the invention;

FIG. 2 is a cross-sectional view illustrating another embodiment of an armored glass composite according to the invention;

FIG. 3 is a cross-sectional view illustrating another embodiment of an armored glass composite according to the invention;

FIG. 4 is a cross-sectional view illustrating another embodiment of an armored glass composite according to the invention;

FIG. 5.a illustrates a cross-sectional view of further embodiment according to the invention of an armored glass composite of the invention;

FIG. 5.b is a perspective view of the embodiment of FIG. 5.a;

FIG. 6.a illustrates a cross-sectional view of a first embodiment according to the invention of an armored glass composite of the invention comprising a plate array;

FIG. 6.b is a perspective view of the embodiment of FIG. 6.a;

FIG. 7.a is a cross-sectional view of a second embodiment according to the invention of an armored glass composite of the invention comprising a plate array;

FIG. 7.b is a perspective view of the embodiment of FIG. 7.a.

FIG. 8.a is a cross-sectional view of a third embodiment according to the invention of an armored glass composite of the invention comprising a plate array;

FIG. 8.b is a perspective view of the embodiment of FIG. 8.a.

FIG. 9.a shows transmittance as a function of optical wavelength for machined spinel sheets without a film applied thereon;

FIG. 9.b shows transmittance as a function of optical wavelength for machined spinel sheets with transparent films arranged on both sides thereof; and

FIG. 10 shows photographs of four differently machined glass sheets, in each case with and without a transparent film thereon.

### DETAILED DESCRIPTION

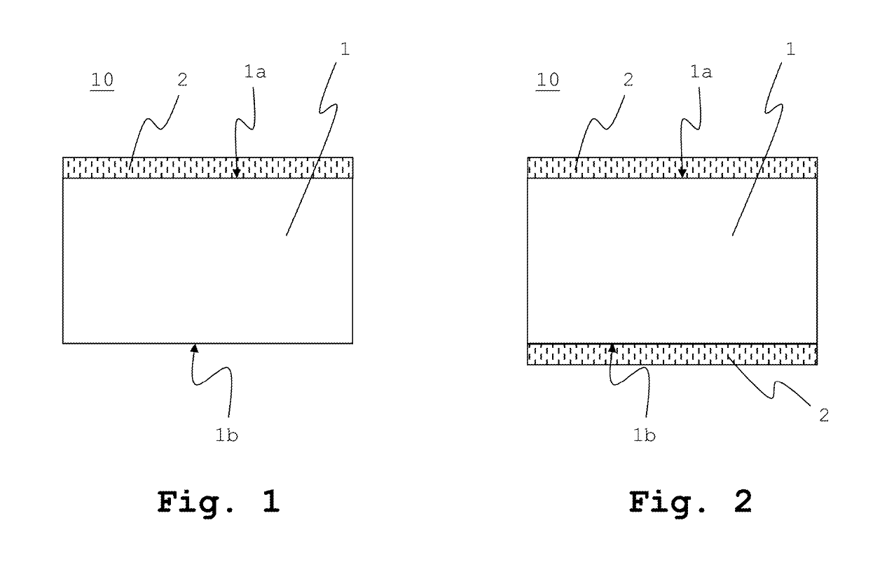

The armored glass composite 10 of the invention will briefly be referred to as a bulletproof pane 10 below. First, FIGS. 1 to 4 show various embodiments of a bulletproof pane 10.

First, FIG. 1 shows a bulletproof pane 10 composed of an opto-ceramic layer 1 and a transparent film 2 or film 2 of a transparent material. The opto-ceramic layer 1 which has a front side 1a and a rear side 1b comprises an opto-ceramic material, for example based on spinel.

Front side 1a of opto-ceramic layer 1 is attributed to an outer side of bulletproof pane 10, and rear side 1b of opto-ceramic layer 1 is attributed to an inner side of bulletproof pane 10. The outer and inner sides of bulletproof pane 10 are defined by the orientation in the assembled state, for example in a vehicle or aircraft. The outer side of bulletproof pane 10 is attributed to the outer side of the vehicle or aircraft. The outer side is therefore the face on which a projectile impinges. The inner side, by contrast, is attributed to the interior of the vehicle or of the aircraft.

The rear side 1b of the opto-ceramic layer 1 in FIG. 1 is, for example, polished so as to be substantially transparent, and is preferably polished to optical grade. By contrast, front side la of opto-ceramic layer 1 is not polished to optical grade but is only milled. Therefore, in total, the opto-ceramic or opto-ceramic layer 1 is not transparent.

The unevennesses and/or roughnesses of front side 1a of the opto-ceramic layer 1 affecting or compromising the optical transparency thereof are compensated by film 2 which is applied to the front side 1a of layer 1.

Film 2 is a flexible PMMA film, for example, which is laminated to the front side 1a of opto-ceramic layer 1 by heating and optionally by appropriately employing overpressure and/or underpressure. Film 2, when sufficiently heated and thus softened, lies upon and/or into the textures formed by the unevenness and roughness of front side 1a. The flexible film 2 offsets these textures so rendering them substantially visually imperceptible. In this way, bulletproof pane 10 defined by opto-ceramic layer 1 and transparent film 2 becomes transparent.

FIG. 2 shows a preferred embodiment of the invention, with an insufficiently transparent front side 1a and an insufficiently transparent rear side 1b of the opto-ceramic layer 1. In order to achieve the required transparency of the armored glass composite 10, a film 2 of transparent material is disposed both on the front side 1a and on the rear side 1b of opto-ceramic layer 1.

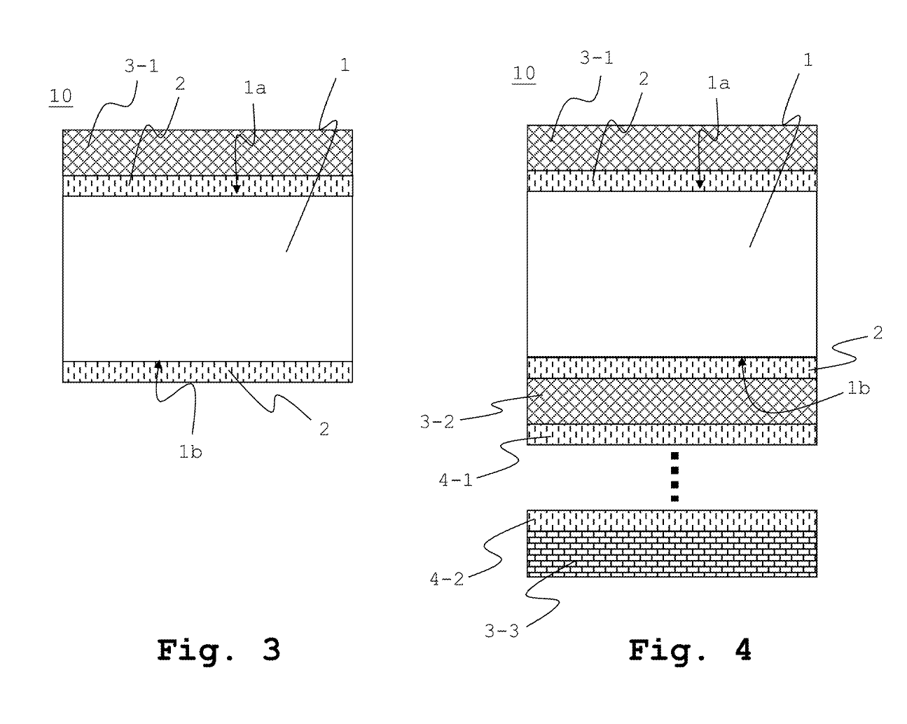

FIG. 3 shows another embodiment in which a further layer 3-1 is disposed on film 2. The further layer 3-1 may be provided, for example, by a layer based on a resin, a glass, or a glass ceramic. In this variation, film 2 additionally functions as a bonding means between layer 1 and further layer 3-1.

Depending on the desired protective effect or protection class to be achieved, bulletproof pane 10 may optionally be extended toward the outside and/or toward the inside by further layers 3-1 to 3-3 and/or further films 4-1 and 4-2.

In this respect, FIG. 4 shows an embodiment in which further films and further layers may be arranged on the film 2 that is disposed on the rear side 1b of opto-ceramic layer 1 in order to increase the protective effect, of which further films only two films 4-1 and 4-2 are shown herein by way of example, and of which further layers only two layers 3-2 and 3-3 are shown herein by way of example. As a final layer 3-3 toward the inside, a sheet based on polycarbonate is provided. Polycarbonate sheet 3-3 is quite ductile and can therefore be deformed readily. It serves as a kind of trap for the projectile and/or its components and/or for splinters, such as glass splinters from the armored glass composite.

In transparent sheet composites 10 that have an antiballistic effect or that are effective against projectile hits and which comprise an opto-ceramic 1, the opto-ceramic 1 is employed in the front region of the bulletproof pane 10. One motivation therefor is that an impacting projectile can be most effectively decelerated and/or deformed by the hard opto-ceramic 1. Projectile herein also refers to splinters and fragments of artillery shells or similar explosive munition, for example.

In FIGS. 3 and 4, the opto-ceramic 1 is employed as a second sheet. Preferably, it is located between two sheets 3-1 and 3-2 made of glass or glass ceramics and is bonded thereto by means of a respective suitable polymer film 2 (see FIG. 4). Since the soft polymer film 2 offsets unevennesses of the opto-ceramic layer 1 so as to render them optically ineffective, in particular independently of the refractive index of the two materials, but in particular also in case that film 2 is sufficiently adapted in thickness and refractive index, the opto-ceramic 1 does not need to be polished laboriously and expensively.

Of course it is possible to achieve an extremely effective composite 10 by using merely at least one opto-ceramic layer 1 and at least one transparent film 2. The effect is appropriately enhanced by additional opto-ceramic layers. Thus, for a ballistic protective effect it is not mandatory to include additional layers of glass.

The antiballistic effect of the entire composite 10 is hardly affected by this offset of the opto-ceramic layer 1 by one position rearwards. This is because the opto-ceramic 1 still causes a deceleration, deformation, and/or fragmentation of the projectile in the front region of the structure 10. Usually, as indicated in FIG. 4, the major part of a preferably laminated layer package will be arranged behind opto-ceramic 1 and is capable to completely stop the projectile by virtue of its large total mass and the final polycarbonate sheet 3-3. Of course this only applies within the bullet-resistance class for which the composite 10 is designed.

Placing a further layer 3-1, for example of glass or glass ceramics, in front of opto-ceramic layer 1 (see FIGS. 3 and 4) moreover offers a number of further advantages.

For example, the further layer 3-1 employed as the first sheet may be a simple flat glass sheet which may, for example, be provided with functionalities, in particular heating, defogging effect (anti-fog), and/or anti-reflective effect.

The heating means may be configured as a TCO layer, for example, or of non-transparent, spaced wires or surface conductors.

Furthermore, in particular a colored sheet may be used as the first sheet, more particularly a sheet colored in portions thereof.

Furthermore, additionally or as an alternative, at least one functional layer may be provided within the composite 10. The at least one functional layer may extend over the whole surface of composite 10 or over sections thereof and may be disposed on the composite 10 or between individual layers 1, 3-1, 3-2, 3-3, and/or films 2, 4-1, 4-2 of the composite 10.

Examples of a functional layer include a layer based on vapor-deposited glasses, in particular with a refractive index gradient for refractive index matching (see DE 10 2008 034 373 A1), a photochromic layer, especially for protecting against brightness in the visible wavelength range and preferably with remaining transmittance in the infrared range, an electrochromic layer, in particular for controlling the transparency, and/or an IR-absorbing and/or IR-reflecting layer, in particular for protection against IR spying.

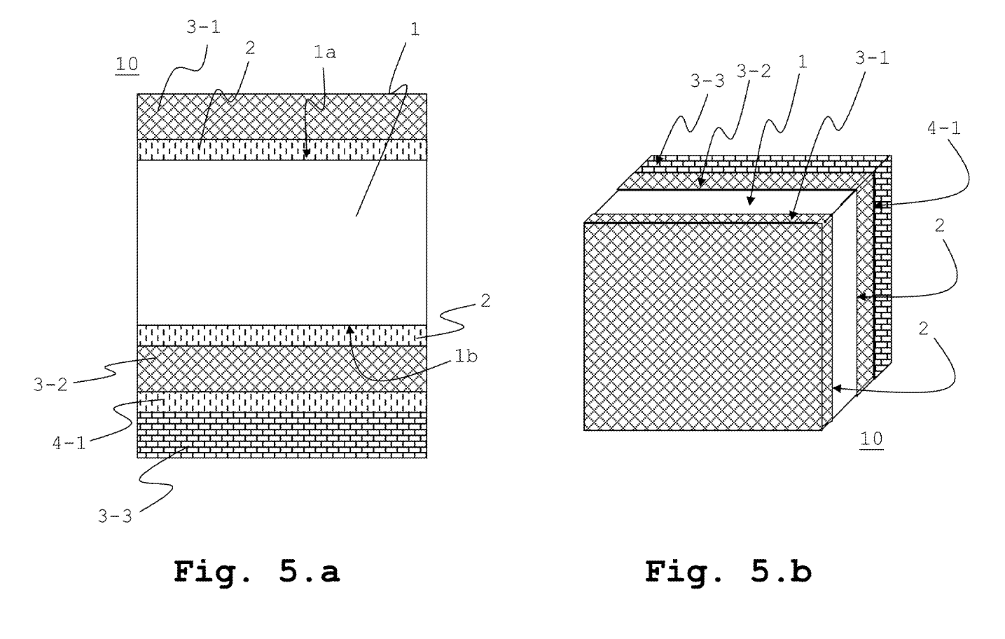

FIGS. 5.a and 5.b schematically illustrate a further inventive embodiment of an armored glass composite 10 according to the invention. The configuration of the bulletproof glass 10 on the front side 1a of opto-ceramic layer 1 corresponds to the structure 10 shown in FIGS. 3 and 4. On the rear side 1b of opto-ceramic layer 1, film 2 is applied, and then a first further layer 3-2, a further film 4-1, and finally a second further layer 3-3. Further film 4-1 corresponds to film 2 and serves as a bonding means between the first further layer 3-2 and the second further layer 3-3. First further layer 3-2 is a glass layer, for example. Second further layer 3-3 which is the last layer in this case and completes the composite 10, is a polycarbonate sheet, for example.

Of course it is also possible to use not only one opto-ceramic layer 1 in the armored glass composite 10, but a plurality of layers at different positions in the composite 10 in order to enhance the antiballistic protection effect.

All of the embodiments described above relate to bulletproof panes 10 in which the opto-ceramic layer 1 is provided by a one-piece integral opto-ceramic. They are particularly useful for bulletproof panes 10 having a surface area of up to about 800 mm×1500 mm, preferably of up to 250 mm×250 mm, more preferably of up to 150 mm×150 mm.

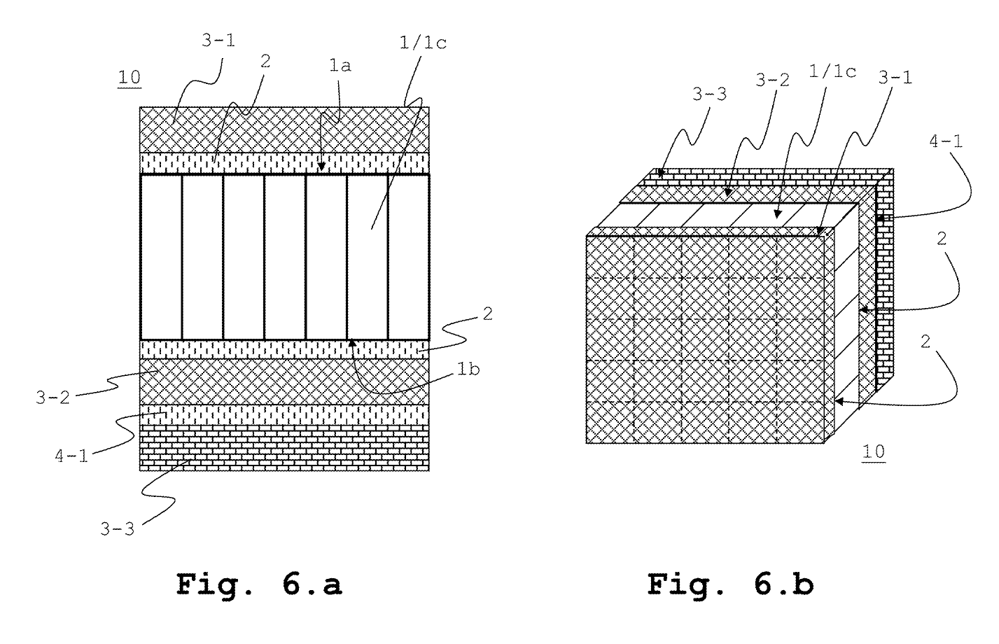

By contrast, FIGS. 6.a and 6.b show an embodiment in which a bulletproof pane 10 is formed of a plurality of small sheets 1c. Specifically, the opto-ceramic layer 1 is composed of a plurality of sheets 1c. This is because with the exception of opto-ceramic 1, all other layers 3-1, 3-2, 3-3 which are based on resin, glass, and/or glass ceramics for example, and films 2, 4-1 which are based on a resin and/or an inorganic layer, for example, can be produced in substantially larger dimensions. Opto-ceramic layer 1 is composed of a plurality of opto-ceramic plates 1c. Opto-ceramic layer 1 is formed by an array of opto-ceramic plates 1c. Except for opto-ceramic layer 1, the structure of this bulletproof pane 10 corresponds to the structure of the bulletproof pane 10 shown in FIGS. 5.a and 5.b.

The division of a large sheet 1 into many small parts 1c which do not directly touch each other but rather are separated, for example by a film of a bonding means, has the advantage, among others, that a hit by a projectile will not cause cracks that extend throughout the whole layer 1 or the whole window pane so as to possibly rendering it completely opaque, but will make opaque substantially only the plate 1c that was hit.

In one embodiment of the method, first the opto-ceramic layer 1 is provided. For this purpose, the individual plates are assembled to form an array 1c. Plates 1c are juxtaposed side by side to form a sort of a mosaic. Optionally, a bonding means may be provided between the plates 1c or between the edges of plates 1c, in particular for stabilizing the composite 10 or at least the layer 1 and/or to mechanically decouple the plates 1c.

In a next step, film 2 which is based on a flexible PMMA film, for example, is laminated onto opto-ceramic layer 1. Film 2 stabilizes the array of plates 1c and the opto-ceramic layer 1. The further steps of applying the further films 2 and 4-1 and the further layers 3-1 to 3-3 correspond to the steps that have already been described with reference to FIGS. 5.a and 5.b.

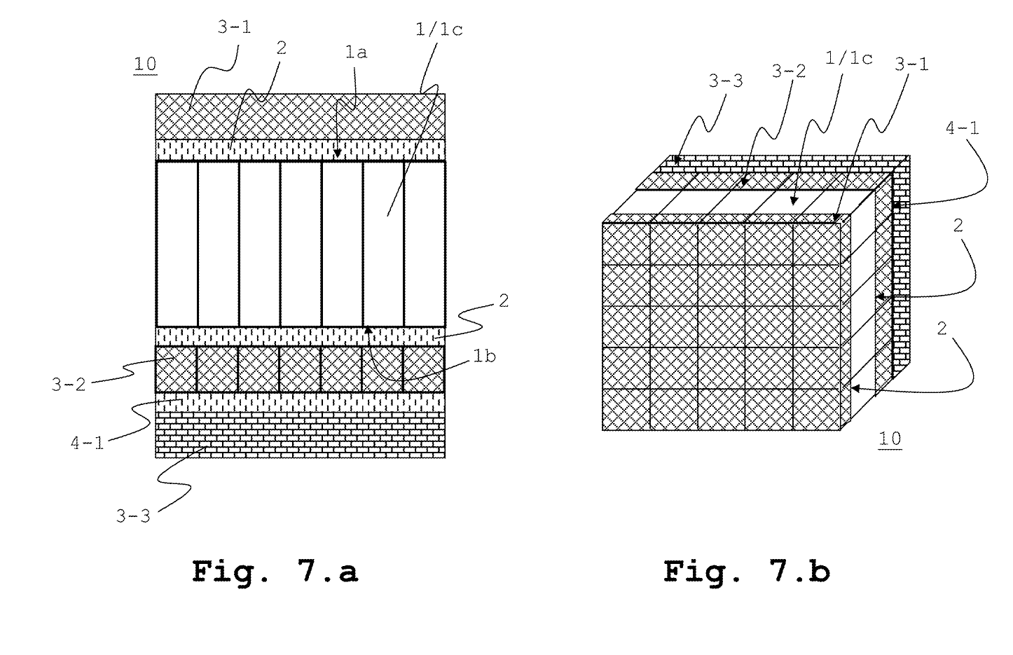

FIGS. 7.a and 7.b show a further variation of bulletproof pane 10 in which not only opto-ceramic layer 1 is composed of plates 1c. In addition, the further layer 3-2 is composed of plates. As a result, in the further layer 3-2, likewise, damage will be limited to the one or more plates located in the sphere of action of the projectile or its fragments.

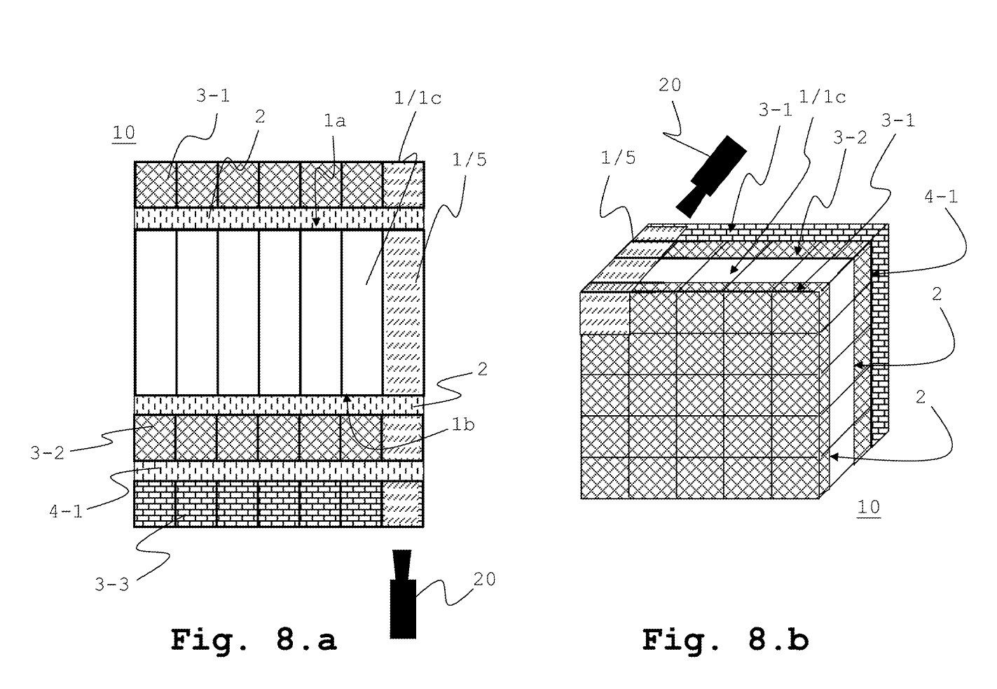

Finally, FIGS. 8.a and 8.b are schematic views of a further bulletproof pane 10. In this composite 10 all layers 1 and 3-1 to 3-3 are composed of plates which are aligned to each other so that the individual plates of layers 1 and 3-1 to 3-3 are substantially stacked one above the other. In addition, it is suggested that one stack of plates 5 is provided by IR-transparent plates. For example, this stack 5 is substantially completely provided by an opto-ceramic 1. So, an IR channel 5 is provided. Behind such an IR channel 5, a camera 20 and/or an IR radiation transfer unit 20 may be placed. This configuration may be implemented so that the IR channel 5 comprises the area of an entire plate and is disposed, for example as illustrated, decentralized in a corner of the entire pane, or so that only a portion of each panel provides an IR channel 5.

The functionalities or functional layers mentioned above may be provided for the entire bulletproof pane 10 or for divided systems or systems composed of smaller individual plates, in particular for individual plates.

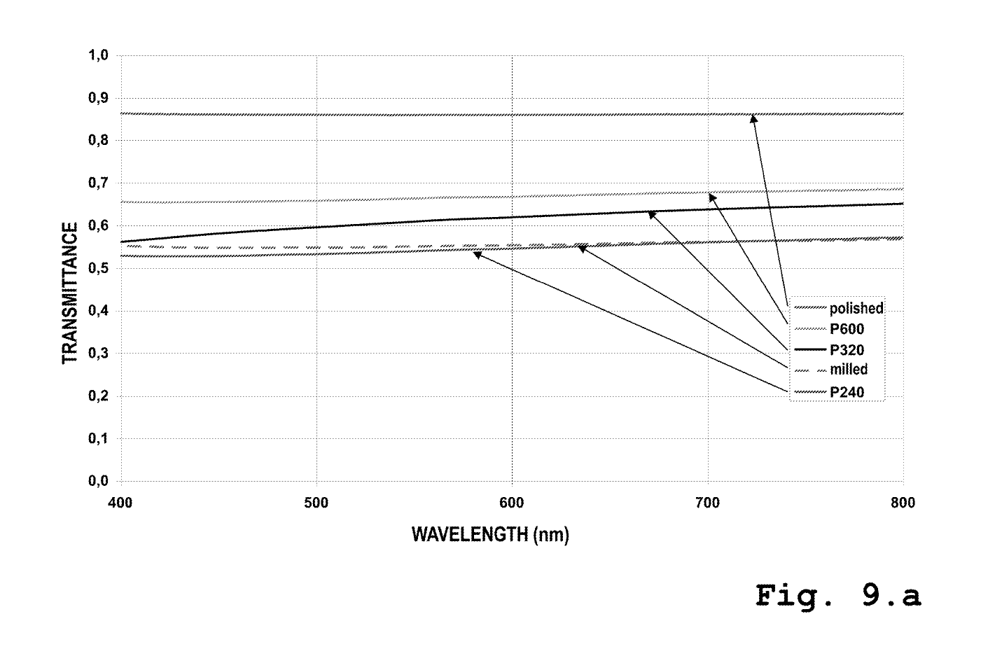

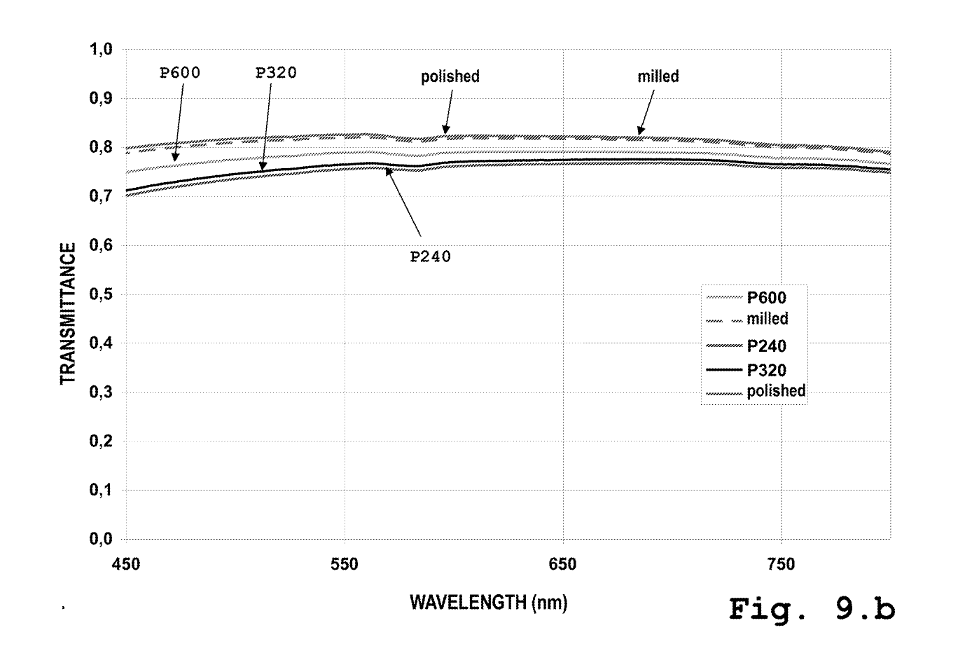

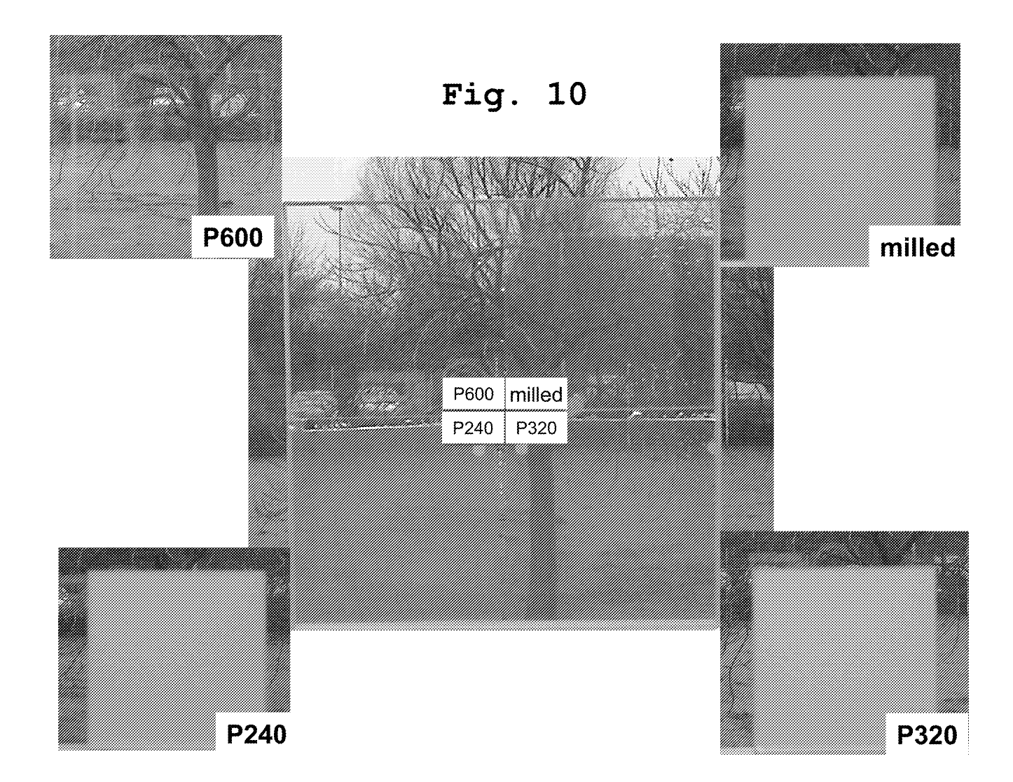

FIGS. 9.a and 9.b show the total transmittance (PvK) including Fresnel losses as a function of optical wavelength in a range from 400 nm to 800 nm for machined spinel plates 1 of a thickness of 4 mm, with and without film 2. Machining was performed on front side 1a and on rear side 1b. Machining was performed by polishing, grinding (P600, P320, and P240), and milling. For details on grinding and milling reference is made to the description of FIG. 10 below.

First, FIG. 9.a shows transmittance (PvK measurement) as a function of optical wavelength for machined spinel plates 1 without a film 2 applied: Polished plate 1 has the highest transmittance which is approximately between 85% and 90% in the range shown. Transmittance decreases with increasing grain size. For P600, transmittance is approximately between 65% and 70% in the range shown. For P320 it is approximately between 55% and 65% in the range shown. For P240 it is approximately between 50% and 60% in the range shown. Transmittance of the milled plate 1 is roughly similar to the transmittance of the plate 1 that was ground using P240.

FIG. 9.b, on the other hand, shows transmittance (PvK measurement) as a function of optical wavelength for machined spinel plates 1 which have a respective transparent film 2 applied on both faces, front side 1a and rear side 1b, which is a TPU film (Hundsman PE 399) of a thickness of 0.76 mm: For all spinel plates 1 except the polished plate 1 transparency was increased. The transmittance of the polished plate 1 is highest, as was to be expected. It is approximately between 79% and 85% in the range shown, which is lower when compared to FIG. 9.a. Surprisingly, however, the transmittance of the milled plate 1 is roughly similar to the transmittance of the polished plate 1. Moreover, it is greater than the transmittance of the plates 1 that were ground. For the ground plates 1, transmittance decreases with increasing grain size. For P600 it is approximately between 75% and 80% in the range shown. For P320 it is approximately between 70% and 78% in the range shown. For P240 it is approximately between 70% and 78% in the range shown.

To demonstrate the effect of the invention, FIG. 10 finally shows photographs of glass sheets machined to different fine or coarse degrees, without the transparent film 2 (each of the lateral photographs) and with the transparent film 2 which is provided by a flexible film here (each of the photographs in the center).

Three of the four sheets were ground using different grain sizes: P600 (grain size 25.8±1 μm), P320 (grain size 46.2±1.5 μm), and P240 (grain size 58.5±2 μm). The roughness values of the machined sheets are roughness characteristics for P600 with Ra values of 0.36 μm and RMS values of 0.49 μm; roughness characteristics for P320 with Ra values of 0.67 μm and RMS values of 0.89 μm; and roughness characteristics for P240 with Ra values of 1.72 μm and RMS values of 2.25 μm. One of the four layers was only milled (top right), exhibiting roughness characteristics with Ra values of 1.60 um and RMS values of 2.07 μm. This corresponds roughly to the roughness characteristics of the sheet ground with P240.

The best result is achieved with the sheet which was ground with the smallest grain size (P600). However, at the same time this is the most expensive method. Transparency is provided with and without a film. The other three sheets are substantially translucent without the film, and therefore not transparent. With the applied film, however, transparency can be produced. Surprisingly it was found here that the milled layer, i.e. the layer with the roughest surface, exhibits a better result than the two ground sheets (P250 and P320). It is assumed that the film more easily lies into or on the larger textures of the milled surface and therefore renders these textures visually ineffective.

It will be apparent to a person skilled in the art that the embodiments described are only given by way of example. The invention is not limited to these embodiments but may rather be varied in many ways without departing from the scope and spirit of the invention. Features of individual embodiments and the features mentioned in the general part of the description may be combined among and with each other.

### LIST OF REFERENCE NUMERALS

1 Opto-ceramic layer
1a Front side of opto-ceramic layer
1b Rear side of opto-ceramic layer
1c Plate of opto-ceramic layer
2 Transparent film or transparent flexible film
3-1 First further layer
3-2 Second further layer
3-3 Third further layer
4-1 First further film
4-2 Second further film

Stack of plates, or channel, in particular for IR radiation Armored glass composite, or bulletproof pane, or protective glazing Camera and/or transfer unit, in particular for IR radiation

What is claimed is:

1. A transparent armored glass composite, comprising:
at least one sintered opto-ceramic layer having a front side and a rear side;
a film of a transparent material disposed on the front side and/or on the rear side of the at least one sintered opto-ceramic layer to form a composite, wherein the film is integrally connected to the opto-ceramic layer so that a transparency of the composite is greater than a transparency of the at least one sintered opto-ceramic layer alone; and
a glass or glass ceramic sheet is arranged on the front side or on the rear side, the glass or glass ceramic sheet having a roughness of less than 20 nm.

2. The armored glass composite as claimed in the claim 1, wherein, prior to being disposed on the at least one sintered opto-ceramic layer, the at least one sintered opto-ceramic layer has a transmittance, as measured by PvK measuring method, of less than 80% in a range of wavelengths from 350 nm to 800 nm.

3. The armored glass composite as claimed in claim 1, wherein the at least one sintered opto-ceramic layer has a roughness in a range of greater than 0.01 μm (Ra value) or of greater than 0.01 μm (RMS value).

4. The armored glass composite as claimed in claim 1, wherein the composite which in particular at least comprises the opto-ceramic layer and the film disposed on the opto-ceramic layer has a transmittance (as measured by PvK measuring method) of greater than 40% in a range of wavelengths from 350 nm to 800 nm.

5. The armored glass composite as claimed in claim 1, wherein the glass or glass ceramic sheet is selected from the group consisting of a glass sheet with a floated surface, a glass sheet with a polished surface, a glass sheet with a fire-polished surface, a rolled glass sheet, and a rolled glass ceramic sheet.

6. The armored glass composite as claimed in claim 1, wherein the roughness of the glass or glass ceramic sheet is less than 15 nm.

7. The armored glass composite as claimed in claim 1, wherein the roughness of the glass or glass ceramic sheet is from 2 to 10 nm.

8. The armored glass composite as claimed in claim 1, wherein the at least one sintered opto-ceramic layer comprises two opto-ceramic layers.

9. The armored glass composite as claimed in claim 8, wherein the two opto-ceramic layers comprise different materials.

10. The armored glass composite as claimed in claim 8, wherein the two opto-ceramic layers comprise spinel and aluminum oxide.

11. The armored glass composite as claimed in claim 1, further comprising a first sheet on the front side that has a roughened lower surface sufficient to improve a material bond to a resin film or to a TCO film.

12. The armored glass composite as claimed in claim 1, further comprising a film of a resin material containing inorganic nanoparticles.

13. The armored glass composite as claimed in claim 1, further comprising at least two resin films of different refractive indices.

14. The armored glass composite as claimed in claim 1, further comprising at least one tempered sheet.

15. The armored glass composite as claimed in claim 1, wherein the front side or the rear side of the at least one sintered opto-ceramic layer is not polished to optical grade.

16. The armored glass composite as claimed in claim 1, wherein the front side or the rear side of the at least one sintered opto-ceramic layer has a surface finish selected from the group consisting of a milled surface, a lapped surface, an ultrasonically lapped surface, a sandblasted surface, a ground surface, a sawn surface, and an etched surface.

17. The armored glass composite as claimed in claim 1, wherein the at least one sintered opto-ceramic layer has a refractive index that differs from a refractive index of the film by less than 0.7.

18. The armored glass composite as claimed in claim 1, wherein the film comprises at least one material selected from the group consisting of resin, glass, ceramic, opto-ceramic, ZnS ceramic, and glass ceramic.

19. The armored glass composite as claimed in claim 1, further comprising at least one functional layer, the at least one functional layer being as a separate film or being integrated in the at least one sintered opto-ceramic layer or in the film.

20. The armored glass composite as claimed in claim 19, wherein the functional layer is at least one layer selected from the group consisting of a heating layer, an anti-fog layer, an anti-reflective layer, a vapor-deposited glass layer for refractive index matching, a photochromic layer, an electrochromic layer, a thermochromic layer, an IR-absorbent layer, an IR-reflective layer, a radiation-reflective layer, an anti-scratch layer, and a diamond-like carbon (DLC) coating.

21. The armored glass composite as claimed in claim 1, wherein at least the at least one sintered opto-ceramic layer comprises an array of individual plates.

22. The armored glass composite as claimed in claim 1, wherein at least a portion of the at least one sintered opto-ceramic layer is curved.

23. The armored glass composite as claimed in claim 1, wherein the armored glass composite is configured for a use selected from the group consisting of a window pane for civilian vehicles, a window pane for military vehicles, a window pane for aircraft, a window pane for missiles, a window pane for watercraft, a window pane for underwater vehicles, a window pane for buildings, and protective clothing

24. A method for producing a transparent armored glass composite, comprising the steps of:
providing an opto-ceramic layer; and
bonding at least one film of a transparent material to a front side or a rear side of the opto-ceramic layer to form a composite so that a transparency of the composite is increased as compared to a transparency of the opto-ceramic layer.
